(19) United States
(12) Patent Application Publication
(10) Pub. No.: US 2009/0127830 A1
(43) Pub. Date: May 21, 2009

(54) Shopping Bag Carrier

(76) Inventors: Shweta Soni, Miami Beach, FL (US); Gautam Verma, Miami Beach, FL (US)

Correspondence Address: CHRISTOPHER J. VANDAM, P.A., 19600 NE 21 Ct., MIAMI, FL, 33179, US

(21) Appl. No.: 12/122,502

(22) Filed: May 16, 2008

Related U.S. Application Data
(60) Provisional application No. 60/988,550, filed on Nov. 16, 2007.

(51) Int. Cl. B62B 1/20

(52) U.S. Cl. 280/659

(57) ABSTRACT

A shopping bag carrier that in one embodiment has a shaft with a wheel at the lower end, a handle at the upper end and a series of hooks along the shaft. An embodiment is provided with a telescopically collapsible shaft allowing easier transport when the device is not in use carrying shopping bags. In an embodiment hooks are cut out of the shaft to facilitate carrying a shopping bag handle yet retaining the ability to permit the shaft to collapse telescopically. In an embodiment a fender is included over a portion of the wheel to aid in preventing the wheel from rolling when leaning the device against a vertical surface at rest.

1. Applicant hereby claims priority to U.S. Provisional Patent Application No. 60/988,550, filed on Nov. 16, 2007, which is hereby incorporated by reference.

### BACKGROUND OF THE INVENTION

1. Field of the Invention

The present invention relates to assistive devices, and more particularly, to a device particularly suited to carry shopping bags

2. Description of the Related Art

Several designs for bag carriers have been designed in the past. None of them, however, include a highly collapsible shaft with multiple cutouts in the shaft to attach bags and a brake to allow the device to lean against a vertical surface.

Applicant believes that the closest reference corresponds to U.S. Pat. No. 5,697,624 issued to Abdul-Razzak Faraj. However, it differs from the present invention because the present device does not include external hooks or a storage compartment and further includes, at least in some embodiments, inter alia, internal hooks a collapsing shaft and a means to prevent the wheel from rolling at rest.

Other patents describing the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide a device to aid a person carrying one or more bags.

It is another object of this invention to provide a device that is collapsible and thus easily transportable when not in use.

It is still another object of the present invention to provide a compact bag carrier that can be stably leaned against a vertical surface at rest.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents an elevation view of an embodiment of the device fully extended.

FIG. 2 shows a detailed elevation view of a wheel assembly.

FIG. 3 illustrates a detailed elevation view of a bag hooking means.

FIG. 4 is a representation of a person using an embodiment of the device to carry bags.

FIG. 5 is an elevation view an embodiment of the device holding shopping bags and leaning against a vertical surface.

FIG. 6 is a perspective view of an embodiment of the device.

FIG. 7 is a perspective view of an embodiment of the device.

### DETAILED DESCRIPTION OF THE PREFERRED EMBODIMENT

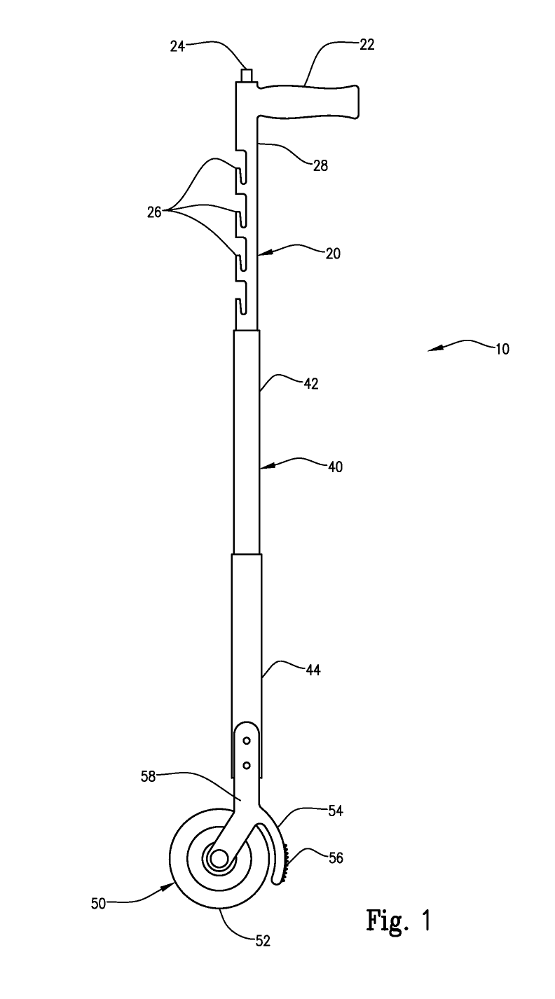

Referring now to the drawings, where the present device is generally referred to with numeral 10, it can be observed in FIG. 1 that it basically includes, inter alia, an upper assembly 20, a shaft assembly 40 and a wheel assembly 50. Said upper assembly 20 further comprises, inter alia, a handle 22, a button 24, hooks 26 and a stud 28. Said shaft assembly 40 further comprises, inter alia, a stud 42 and a stud 44. Said wheel assembly 50 further comprises, inter alia, a wheel 52, a fender 54, a grip 56 and a fork 58.

Still referring to FIG. 1, where the device is shown fully telescopically extended, the handle 22 provides a gripping surface for a user of the device to hold while the device is in use. Handle 22 is preferably constructed of a soft and durable material that provides some padding function to a user of the device, for example, foam, neoprene, rubber or padded leather. The dimensions of said handle 22 are such that a human hand can ergonomically grasp the handle 22 to reduce fatigue and increase the force that can be applied to the handle 22 when the device is fully extended and in use.

When the device is fully telescopically extended the button 24 may be depressed to trigger an internal mechanism to allow the shaft assembly 40 to telescopically collapse. The button 24 may also be depressed when the shaft assembly 40 is fully collapsed to trigger an internal mechanism to release the stud 42 and stud 44 of the shaft assembly 40 so that the shaft assembly 40 may be telescopically extended to its full length.

When the device is being telescopically collapsed the button 24 is depressed that unlocks stud 28 from stud 42 so that stud 28 is permitted to slide into stud 42. When stud 28 is fully inserted into stud 42 the bottom end of stud 28 interacts with a releasing mechanism inside the bottom of stud 42 thereby permitting stud 42 (which already contains stud 28) to then slide into stud 44 thereby greatly reducing the overall length of the device. When the device is in its fully collapsed state it is easier to carry.

FIG. 1 shows three studs, to with stud 28, stud 42 and stud 44. It has been demonstrated to be equally or more effective to have additional stud sections (not depicted in FIG. 1) between stud 28 and stud 44 to permit the device to collapse into an even shorter form factor increasing the device's portability even more.

Studs 28, 42 and 44, as well as additional studs if included, are optimally constructed of a rigid and durable material. It is contemplated to make these studs of a material, such as for example, an aluminum alloy or synthetic polymer. The cross-section of these studs may be, for example, round, oval, rectangular or other polygon suitable to be aesthetically pleasing and lending itself to such performance characteristics to permit the device to be light weight and strong.

Along the length of stud 28 are a series of hooks 26. The hooks 26 are shown in more detail in FIG. 3. Hooks 26 are generally formed from material removed from said stud 28 so that there are no protrusions on stud 28 that could inhibit stud 28 from collapsing inside stud 42.

In typical use the device is fully telescopically extended, meaning that stud 28, stud 42 and stud 44 (and additional studs, if present as described above) are pulled away from each other yet remain attached to each other at the respective ends of the studs. When the device is fully telescopically extended said stud 28 is telescopically removed from stud 42 thereby exposing the hooks 26. Hooks 26 are dimensioned to receive any of the typical range of shopping bag handles. One or more bag handles may be placed into each of the hooks 26.

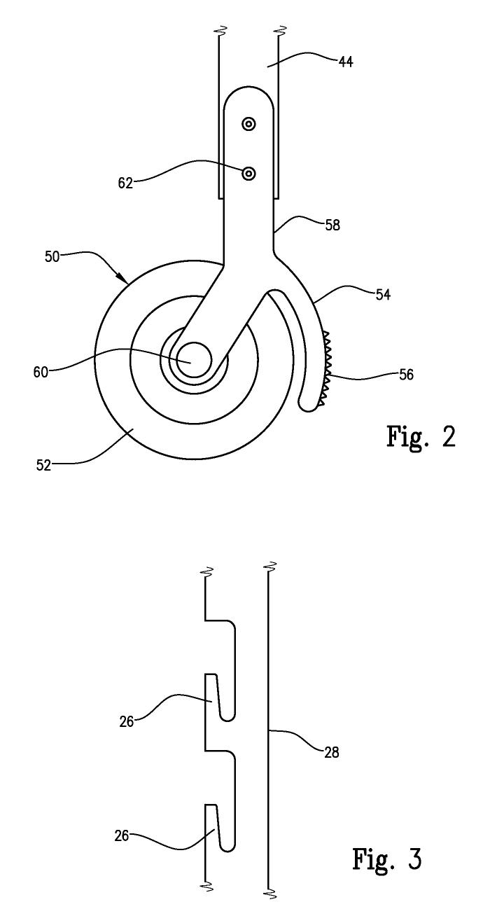

FIG. 1 shows the wheel assembly 50 where it is affixed to the bottom end of stud 44. FIG. 2 shows in more detail the wheel assembly 50 that comprises, inter alia, wheel 52, fender 54, grip 56, fork 58, axle 60 and fasteners 62. The fork 58 connects to the lower end of stud 44 by means of a fastener 62 that may be, for example, a rivet, screw, pin, weld or clip as appropriate. Fork 58 holds the wheel 52 onto the device at the lower end of stud 44. The wheel 52 is permitted to radially rotate around the axle 60 that is fixed onto the fork 58. Optimally the axle 60 includes a means to permit the free rotation of the wheel 52 such as ball bearings, roller bearings or other suitable and durable means.

Still referring to FIG. 2, the fork 58 is connected to a fender 54. On the side of the fender 54 opposite the wheel 53 is a grip 56. One of the functions of the fender 54 and grip 56 is to allow the device to lean against a vertical surface when a user of the device wishes to stop the movement of the device. To effectuate this, a user would lean the device so that the grip 56 contacts the ground and the wheel 52 is lifted off the ground. In other words, the device is leaned so that the fender 54 and grip 56 are positioned between the wheel 52 and the ground thereby preventing the bottom end of the device from moving relative to the ground. This may be useful for a user who has been carrying heavy bags with the device and is required to use both hands, for example at a cash register or for rest, and does not want to lay the device on the ground. The user can instead then prop the device against the vertical surface and on the fender 54 and grip 56 and the device will stay in place and not roll.

FIG. 3 shows in more detail the hooks 26 formed into a shaft 28. The hooks 26 are, in this embodiment, integral to the shaft 28 and do not extend beyond the plane of the outer surface of the shaft 28 so that the shaft 28 may be telescopically collapsed into shaft 42 (shown in FIG. 1).

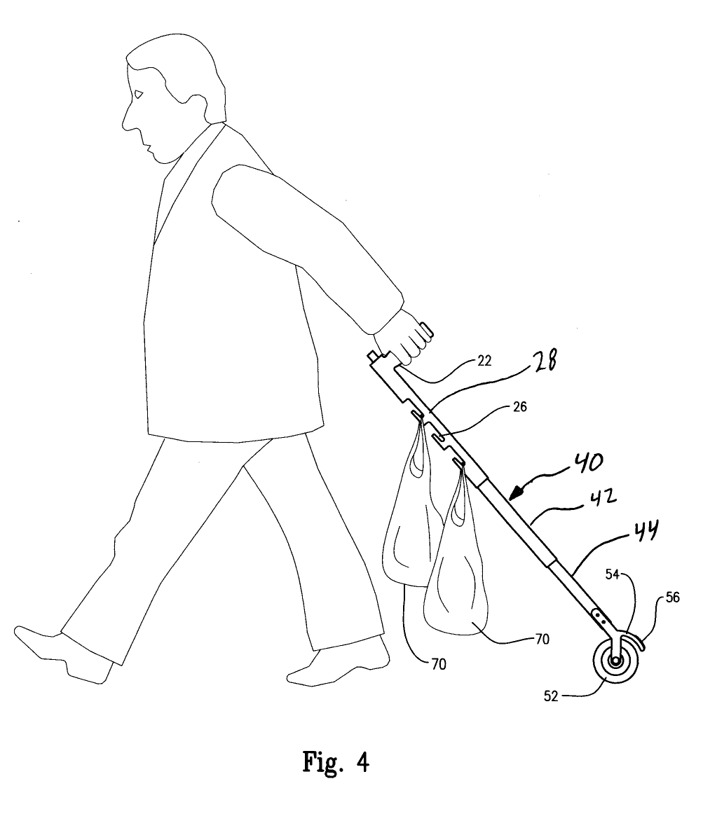

FIG. 4 is an example of the device in typical use by a person to carry bags 70. The bags 70 may be any of a wide variety of bags commonly in use for shopping such as, for example, plastic bags, fabric bags and paper bags with a handle. The handle of any bag desired to be carried by the device is inserted into a hook 26. A person using the device grasps the handle 22 with the person's hand to pull the device. The device could equally be pushed in front of a person using the device. When pulling the device the wheel 52 contacts the ground and freely rotates to permit a person to carry bags 70 with less effort than if the bags 70 were carried directly by a person's hand without the device. In typical use of the device when carrying bags 70 while in motion the fender 54 and grip 56 are positioned above the wheel 52 so that they to not impede the wheel 52 from rotating when in motion.

Also demonstrated in FIG. 4 is the shaft assembly 40 where it is shown to include, inter alia, stud 28, stud 42 and stud 44. In this embodiment stud 28 has a greater diameter than stud 42 that in turn has a greater diameter than stud 44. This is in contrast to the embodiment of the device as shown in FIG. 1 where stud 44 has a greater diameter than stud 42 that in turn has a greater diameter than stud 28.

Still referring to FIG. 4, when the device is being telescopically collapsed the stud 44 slides into stud 42. When stud 44 is fully inserted into stud 42 the upper end of stud 44 interacts with a releasing mechanism inside the upper end of stud 42 thereby permitting stud 42 (which already contains stud 44) to then slide into stud 28 thereby greatly reducing the overall length of the device. When the device is in its fully collapsed state it is easier to carry when no bags 70 are engaged into hooks 26.

FIG. 4 shows three studs, to with stud 28, stud 42 and stud 44. It has been demonstrated to be equally or more effective to have additional stud sections (not depicted in FIG. 4) between stud 28 and stud 44 to permit the device to collapse into an even shorter form factor increasing the device's portability even more. Any additional stud sections may telescopically collapse in similar fashion to that described above for stud 28, stud 42 and stud 44.

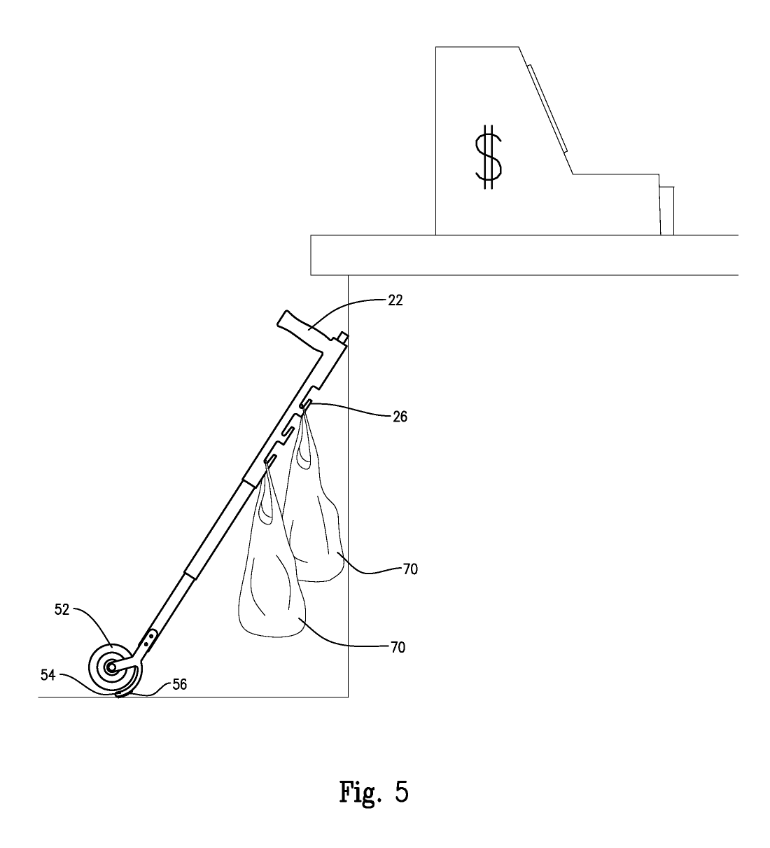

FIG. 5 is an example of the device as it may be used to carry bags 70 while at rest. The device may be leaned against a vertical surface so that the handle 22 contacts the vertical surface. To prevent the device from falling over and potentially damaging any contents of the bags 70 the grip 56 on the fender 54 is in contact with the ground and is kept stationary by the friction between the ground and the grip 56. The wheel 52 is kept from contacting the ground by the fender 54. The device could be effectively used in this manner when, for example, a person using the device needs the use of both hands at a cash register station to make an additional purchase of goods that may be soon to be carried by the device.

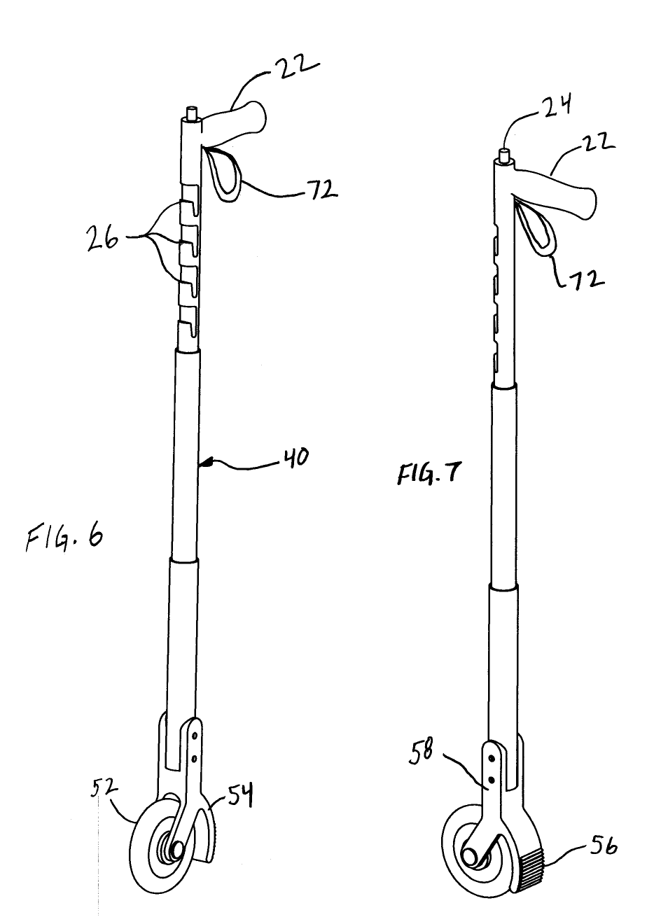

FIG. 6 and FIG. 7 demonstrate a perspective view of an embodiment of the device that is shown to further comprise a wrist strap 72. The wrist strap 72 provides a means to more securely attach the device to a person suing the device to carry bags when the device is fully telescopically extended as well as providing a means to more easily carry the device when it is telescopically collapsed.

Generally, in typical use of the device a user will carry the fully collapsed device, possibly by hand or in a purse. When a purchase is made a vendor delivers the articles in a bag to the user. The user then fully extends the device which locks it at its full length and exposes the hooks 26. The user then places the handle of a bag into any of the hooks 26. The user can then pull the device with the bag securely hanging from the hook 26. Much of the weight contained in the bag is then borne by the device and not directly by the user. This provides an easier way to transport more weight over a longer distance for a longer period of time than would otherwise be comfortable.

An embodiment of a shopping bag carrier is shown to comprise a telescoping shaft with multiple sections and having a first end, a second end and an edge along the side of said telescoping shaft extending between said first end and said second end; a handle dimensioned to fit a human hand affixed to said first end of said telescoping shaft; a wheel rotatably affixed to said second end of said telescoping shaft; and a hook integral to said edge suitable for accepting a handle of a bag and capable of supporting the weight of said bag and its contents.

Embodiments may also be further characterized by a multiplicity of hooks integral to said longitudinal edge and each hook being suitable for accepting a handle of a bag and capable of supporting the weight of said bag and its contents; a wrist strap affixed to said first end of said telescoping shaft; by said wheel being rotatably affixed to a caster and said caster being affixed to said second end of said telescoping shaft; said telescoping shaft having multiple sections that elongate telescopically and are lockable at the full length of said telescoping shaft and said sections also being selectively telescopically collapsible to shorten said telescoping shaft; or by a fender attached to said second end of said telescoping shaft that partially covers said wheel where said fender being positioned to permit said wheel to freely rotate on a ground surface when a user is pulling said handle and said fender is positionable between said wheel and said ground surface when said handle is leaned against a vertical surface and said fender being capable of supporting the weight of said shopping bag carrier and the contents of one or more bags.

An alternate embodiment of a shopping bag carrier may comprise a shaft having a first end, a second end and an edge along the side of said shaft extending between said first end and said second end; a handle dimensioned to fit a human hand affixed to said first end of said shaft; a wheel rotatably affixed to said second end of said shaft; a hook integral to said edge suitable for accepting a handle of a bag and capable of supporting the weight of said bag and its contents; and a fender attached to said second end of said shaft that partially covers said wheel; said fender being positioned to permit said wheel to freely rotate on a ground surface when a user is pulling said handle and said fender is positionable between said wheel and said ground surface when said handle is leaned against a vertical surface; said fender being capable of supporting the weight of said shopping bag carrier and the contents of one or more bags.

This embodiment may be further characterized in that said shaft is telescopically extendable for use in carrying a bag and telescopically collapsible when not in use; multiple hooks integral to said edge and each hook being suitable for accepting a handle of a bag and capable of supporting the weight of said bag and its contents; a wrist strap affixed to said first end of said shaft; or by said wheel being rotatably affixed to a caster and said caster is affixed to said second end of said shaft.

Yet another embodiment of a shopping bag carrier is shown to comprise a shaft having a first end, a second end and an edge along the side of said shaft extending between said first end and said second end; a handle dimensioned to fit a human hand affixed to said first end of said shaft; a wheel rotatably affixed to said second end of said shaft; and a multiplicity of hooks integral to said edge each suitable for accepting a handle of a bag and capable of supporting the weight of said bag and its contents.

This embodiment may be further characterized by a multiplicity of hooks integral to said edge and each hook being suitable for accepting a handle of a bag and capable of supporting the weight of said bag and its contents; a wrist strap affixed to said first end of said shaft; or where said wheel being rotatably affixed to a caster and said caster is affixed to said second end of said shaft.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A shopping bag carrier comprising
a) A telescoping shaft with multiple sections and having a first end, a second end and an edge along the side of said telescoping shaft extending between said first end and said second end
b) A handle dimensioned to fit a human hand affixed to said first end of said telescoping shaft
c) A wheel rotatably affixed to said second end of said telescoping shaft
d) A hook integral to said edge suitable for accepting a handle of a bag and capable of supporting the weight of said bag and its contents.

2. A shopping bag carrier as set forth in claim 1 further characterized by a multiplicity of hooks integral to said longitudinal edge and each hook being suitable for accepting a handle of a bag and capable of supporting the weight of said bag and its contents.

3. A shopping bag carrier as set forth in claim 1 further characterized by a wrist strap affixed to said first end of said telescoping shaft.

4. A shopping bag carrier as set forth in claim 1 further characterized by said wheel being rotatably affixed to a caster and said caster being affixed to said second end of said telescoping shaft.

5. A shopping bag carrier as set forth in claim 1 further characterized by said telescoping shaft having multiple sections that elongate telescopically and are lockable at the full length of said telescoping shaft and said sections also being selectively telescopically collapsible to shorten said telescoping shaft.

6. A shopping bag carrier as set forth in claim 1 further characterized by a fender attached to said second end of said telescoping shaft that partially covers said wheel; said fender being positioned to permit said wheel to freely rotate on a ground surface when a user is pulling said handle and said fender is positionable between said wheel and said ground surface when said handle is leaned against a vertical surface;
said fender being capable of supporting the weight of said shopping bag carrier and the contents of one or more bags.

7. A shopping bag carrier comprising
a) A shaft having a first end, a second end and an edge along the side of said shaft extending between said first end and said second end
b) A handle dimensioned to fit a human hand affixed to said first end of said shaft
c) A wheel rotatably affixed to said second end of said shaft
d) A hook integral to said edge suitable for accepting a handle of a bag and capable of supporting the weight of said bag and its contents.
e) a fender attached to said second end of said shaft that partially covers said wheel; said fender being positioned to permit said wheel to freely rotate on a ground surface when a user is pulling said handle and said fender is positionable between said wheel and said ground surface when said handle is leaned against a vertical surface; said fender being capable of supporting the weight of said shopping bag carrier and the contents of one or more bags.

8. A shopping bag carrier as set forth in claim 7 further characterized in that said shaft is telescopically extendable for use in carrying a bag and telescopically collapsible when not in use.

9. A shopping bag carrier as set forth in claim 7 further characterized by multiple hooks integral to said edge and each hook being suitable for accepting a handle of a bag and capable of supporting the weight of said bag and its contents.

10. A shopping bag carrier as set forth in claim 7 further characterized by a wrist strap affixed to said first end of said shaft.

11. A shopping bag carrier as set forth in claim 7 further characterized by said wheel being rotatably affixed to a caster and said caster is affixed to said second end of said shaft.

12. A shopping bag carrier comprising
a) A shaft having a first end, a second end and an edge along the side of said shaft extending between said first end and said second end
b) A handle dimensioned to fit a human hand affixed to said first end of said shaft
c) A wheel rotatably affixed to said second end of said shaft
d) A multiplicity of hooks integral to said edge each suitable for accepting a handle of a bag and capable of supporting the weight of said bag and its contents.

13. A shopping bag carrier as set forth in claim 12 further characterized by a multiplicity of hooks integral to said edge and each hook being suitable for accepting a handle of a bag and capable of supporting the weight of said bag and its contents.

14. A shopping bag carrier as set forth in claim 12 further characterized by a wrist strap affixed to said first end of said shaft.

15. A shopping bag carrier as set forth in claim 12 further characterized by said wheel being rotatably affixed to a caster and said caster is affixed to said second end of said shaft.
